(19) United States
(12) Patent Application Publication
(10) Pub. No.: US 2025/0150372 A1
(43) Pub. Date: May 8, 2025

(54) METHOD AND APPARATUS FOR ESTIMATING TOTAL LINK SERVICE RATE USING PACKET METADATA

(71) Applicant: ELECTRONICS AND TELECOMMUNICATIONS RESEARCH INSTITUTE, Daejeon (KR)

(72) Inventors: Jinoo JOUNG, Seoul (KR); Ju Hyeok KWON, Seoul (KR); Jeong Dong RYOO, Daejeon (KR); Tae Sik CHEUNG, Daejeon (KR)

(73) Assignee: ELECTRONICS AND TELECOMMUNICATIONS RESEARCH INSTITUTE, Daejeon (KR)

(21) Appl. No.: 18/937,322

(22) Filed: Nov. 5, 2024

(30) Foreign Application Priority Data
Nov. 6, 2023 (KR) 10-2023-0151697
Oct. 18, 2024 (KR) 10-2024-0142794

(51) Int. Cl. H04L 43/0876; H04L 47/2441

(52) U.S. Cl. CPC H04L 43/0876; H04L 47/2441

(57) ABSTRACT

According to an aspect of the present disclosure, there is provided a method for estimating a total link service rate using packet metadata, the method comprising: extracting a packet satisfying a predetermined condition from each flow; extracting a link service rate from metadata of the extracted packet; and estimating a total link service rate based on the extracted link service rate, wherein the packet satisfying the predetermined condition is determined based on an estimation reference time and finish times of consecutive packets, and wherein the finish times indicates ideal transmission finish times of the packets.

### CROSS REFERENCE TO RELATED APPLICATION

This application claims priority from Korean Patent Application Nos. 10-2023-0151697, filed on Nov. 6, 2023, and 10-2024-0142794, filed on Oct. 18, 2024, which are hereby incorporated by reference for all purposes as if fully set forth herein.

### TECHNICAL FIELD

The present disclosure relates to a method and apparatus for estimating a total link service rate using packet metadata.

### BACKGROUND

The statements in this section merely provide background information related to embodiments of the present disclosure and may not constitute a related art.

Many studies have been conducted on methods to ensure end-to-end latency bounds in networks. To satisfy the performance requirements of each flow in a network, it is essential to maintain a total service rate of flows on each link below a maximum capacity of a corresponding link. To ensure this, the following actions are performed through an admission control process before data transmission for each flow:

A corresponding flow's service rate is informed to a node.

The node checks whether a total service rate on each link through which the flow passes is maintained below the link's capacity.

The node accepts a flow ingress.

A representative example of such an admission control protocol is RSVP (Resource reSerVation Protocol). In this process, in order to respond to changes such as protocol signal loss, node state fluctuations, and flow terminations, each node must maintain and manage information like the service rate of individual flows in order to know the total service rate. This flow-specific information will be referred to as “flow state information.” RSVP maintains a soft state for each flow.

However, as the number of flows increases, it becomes very complicated to individually manage flow state information for each flow. Moreover, it becomes even more challenging to ensure that the flow state information recorded at all nodes remains consistent. Therefore, a method is required to estimate a total link service rate so that a packet ingress control can be performed without managing flow state information.

### SUMMARY

The present disclosure provides a method and apparatus for simply estimating a total link service rate using packet metadata.

The present disclosure also provides a method and apparatus for performing the packet ingress control without managing flow state information.

The objects to be solved by the present disclosure are not limited to the objects mentioned above, and other objects not mentioned will be clearly understood by those skilled in the art from the description below.

According to an aspect of the present disclosure, there is provided a method for estimating a total link service rate using packet metadata, the method comprising: extracting a packet satisfying a predetermined condition from each flow; extracting a link service rate from metadata of the extracted packet; and estimating a total link service rate based on the extracted link service rate, wherein the packet satisfying the predetermined condition is determined based on an estimation reference time and finish times of consecutive packets, and wherein the finish times indicates ideal transmission finish times of the packets.

According to an aspect of the present disclosure, there is provided an apparatus for estimating a total link service rate using packet metadata, the apparatus comprising: a memory having a command stored therein; and a processor configured to extract a packet satisfying a predetermined condition from each flow by executing the command, extract a link service rate from metadata of the extracted packet, and estimate a total link service rate based on the extracted link service rate, wherein the packet satisfying the predetermined condition is determined based on an estimation reference time and finish times of consecutive packets, and wherein the finish times indicate ideal transmission finish times of the packets.

In the present disclosure, it is possible to accurately estimate a total link service rate even at a node subsequent to a first node without managing flow state information.

In the present disclosure, it is possible to easily estimate a total link service rate.

In the present disclosure, it is possible to reduce errors in estimating a total link service rate.

In the present disclosure, it is possible to perform the packet ingress control without managing flow state information.

The present disclosure features low complexity because estimation is performed simply by using estimation times instead of estimation intervals, and there is no need to compensate for flows that are newly allowed to generate packets during an estimation period.

In the present disclosure, it is possible to determine the number of flows that are active at a specific time and the respective service rates of the flows.

In the present disclosure, by specifying a time for estimating a service rate, it is possible to accurately estimate the service rate at a precise point.

The effects of the present disclosure are not limited to the effects mentioned above, and other effects not mentioned will be clearly understood by those skilled in the art from the description below.

### BRIEF DESCRIPTION OF THE DRAWINGS

FIGS. 1A and 1B show the relationships between A(p) and F(p), and L(p) and L′(p).

FIG. 2 is a block diagram of an apparatus for estimating a total link service rate using packet metadata according to an embodiment of the present disclosure.

FIG. 3 is a flowchart illustrating the operation of a metadata management and packet service blocks according to an embodiment of the present disclosure.

FIG. 4 is a flowchart illustrating the operation of a total link service rate estimation block according to an embodiment of the present disclosure.

FIG. 5 is a flowchart illustrating the operation of an estimation period determination block according to an embodiment of the present disclosure.

FIG. 6 is another block diagram of an apparatus for estimating a total link service rate using packet metadata according to an embodiment of the present disclosure.

FIG. 7 is a graph showing an estimation result according to an embodiment of the present disclosure and a result of comparison with Stoica.

### DETAILED DESCRIPTION

Hereinafter, some embodiments of the present disclosure will be described in detail using exemplary drawings. It should be noted that in assigning reference numerals to components in each drawing, the same components are given the same reference numerals as much as possible even when they are shown in different drawings. In addition, in describing the present disclosure, if it is determined that a detailed description of a related known configuration or function may obscure the gist of the present disclosure, the detailed description will be omitted.

In describing components of the embodiment according to the present disclosure, designations such as first, second, i), ii), a), b), and the like may be used. These designations are only used to distinguish the component from other components, and the nature, order, or sequence of the component is not limited by the designations. In the present specification, when it is described that a part ‘includes or comprises’ or ‘has’ a certain component, this means that it does not exclude other components but may further include other components, unless explicitly stated to the contrary.

The detailed description set forth below in conjunction with the accompanying drawings is intended to describe exemplary embodiments of the present disclosure and is not intended to represent the only embodiments in which the present disclosure may be practiced.

The definitions of math symbols used in this specification are as shown in Table 1.

TABLE 1

| Symbol | definition |
|---|---|
| p | p-th packet of the flow |
| h | h-th node on the flow path |
| Fh(p) | Finish time of packet p at node h |
| Ah(p) | Arrival time of packet p at node h |
| L(p) | Length of packet p |
| r, r(p) | Service rate of the flow |
| dh(p) | Delay factor function of packet p at node h |

A flow refers to a set of data packets that have the same information, such as source address, destination address, port number, and protocol.

Packet metadata refers to information about each individual packet transmitted in network communication. The packet metadata is included in a header of a corresponding packet and contains information such as the corresponding packet's source address, destination address, protocol information, port number, packet size, flag information, and timestamp.

The packet metadata is used to track what path the packet takes when transmitted over the network, which system the packet is heading to, and how the communication occurs.

In this specification, a total service rate of a link is referred to as “total link service rate.”

An existing technique for estimating a total link service rate is described in the paper by Stoica (Stoica and H. Zhang, “Providing guaranteed services without per flow management,” ACM SIGCOMM Comput. Commun. Rev., vol. 29, no. 4, pp. 81-94, 1999. (https://doi.org/10.1145/316194.316208)). Hereafter, this paper will be referred to as Stoica.

Stoica describes how to estimate a service rate using the value of b(p)=r*[A(p)−A(p−1)]. Here, p represents a packet, r represents a service rate of a flow to which packet p belongs, p−1 represents an immediately preceding packet of the flow, and A(p) represents an arrival time of packet p at a first node.

The b(p) value is written as packet metadata, and the total service rate is estimated at a subsequent node using b(p). A total sum of the b(p) values for packets arriving during a specific time interval (for example, a predetermined time interval will be referred to as “T”) is divided by T, and this value is used to estimate the total service rate.

However, although this method can estimate an exact value at the first node, the actual arrival time interval of packets at a subsequent node is different from the A(p)−A(p−1) value, which represents the arrival time difference at the first node. Therefore, an error equivalent to a maximum change in packet latency occurs. In addition, while a longer length of period T increases the accuracy of the estimation, it is necessary to compensate for new packet flows that occur during period T. This increases complexity and affects the overall accuracy of the estimation.

In order to solve this problem, an embodiment of the present disclosure proposes a method for simply estimating a total link service rate.

The recently proposed work-conserving stateless fair queueing method [C-SCORE]calculates the “finish time” at each node using packet metadata to determine a service order of packets.

References for the [C-score]can be found as follows.
(1) J. Joung, J. Kwon, J.-D. Ryoo, and T. Cheung, “Scalable flow isolation with work conserving stateless core fair queuing for deterministic networking” IEEE Access, vol. 11, September 2023.
(2) J. Joung, “Work conserving scheduler with global finish time for network latency guarantee,” J. KICS, vol. 48, no. 1, pp. 55-64, 2023. (https://doi.org/10.7840/kics.2023.48.1.55)
(3) J. Joung, J-D. Ryoo, T-S. Cheung, Y Li, and P. Liu, “Latency guarantee with stateless fair queuing,” IETF DetNet WG, Internet draft, draft-joung-detnet-stateless-fair-queuing-01, November 2023.

In [C-SCORE], the finish time of packet p at node h is denoted as Fₕ(p) and is determined as follows.

First, assuming that the node where the first packet arrives is node 0, the finish time F₀(p) at node 0 is calculated as shown in Equation 1.

$${F}_{0} ( p ) = max \{ {F}_{0} ( p - 1 ) , {A}_{0} ( p ) \} + L ( p ) / r \qquad [ Equation 1 ]$$

Here, p represents the p-th packet of the flow, r represents the service rate of the flow to which p belongs, p−1 represents the immediately preceding packet of the corresponding flow, and A(p) represents a time when p arrived at the first node. L(p) represents the length of p.

The finish time F(p) represents the transmission finish time of p calculated fairly in the assumption of an Ideal Fluid Environment, and the service of a node is provided in order of smaller finish times. The finish times according to an embodiment of the present disclosure represent virtual ideal transmission finish times of the corresponding packets.

In Equation 1, F₀(1)=A₀(1)+L(1)/r is satisfied when p=1. The finish time Fₕ(p) at node h after the first node is calculated as in Equation 2.

$${F}_{h} ( p ) = {F}_{h - 1} ( p ) + {d}_{h - 1} ( p ) \qquad [ Equation 2 ]$$

Fₕ₋₁(p) represents the finish time of p at node h−1.

dₕ(p) is called the delay factor (DF) and may be represented by various functions that include factors such as transmission delay, network congestion, and packet processing time. dₕ₋₁(p) is the delay factor of p at node h−1.

As a packet passes through the network, each node records Fₕ₋₁(p) and dₕ₋₁(p) in the packet's metadata. The recorded information is used by node h to calculate Fₕ(p) when the packet arrives at the next node. In this way, a finish time at each node may be continuously updated as a packet moves along the network.

A variation of Equation 1 may be expressed as Equation 3 below.

$${F}_{0} ( p ) = {F}_{0} ( p - 1 ) + {L}^{′} ( p ) / r \qquad [ Equation 3 ]$$

Here, L′(p)/r is defined as a difference between finish times of consecutive packets p−1 and p.

If F₀(p−1)>A₀(p), then L′(p)/r=L(p)/r. In other words, this case occurs when the finish time F₀(p−1) of previous packet p−1 is greater than the arrival time A₀(p) of current packet p. In this situation, since the processing of the previous packet is already completed when packet p arrives, the waiting time of packet p is not affected. Therefore, L′(p)/r=L(p)/r.

On the other hand, if F₀(p−1)≤A₀(p), then L′(p)/r=[A₀(p)−F₀(p−1)]+L(p)/r. In other words, this case occurs when the finish time F₀(p−1) of the previous packet p−1 is less than or equal to the arrival time A₀(p) of current packet p. When packet p arrives, the processing of the previous packet has not yet been completed, so packet p will have additional waiting time. Therefore, L′(p)/r=[A₀(p)−F₀(p−1)]+L(p)/r is satisfied. Here, A₀(p)−F₀(p−1) represents the additional time that packet p must wait.

Furthermore, in Equation 2, dₕ(p) is defined as a function of only node and flow. That is, there is no change in dₕ(p) among packets belonging to a specific flow at a specific node. In other words, the dₕ(p) value remains constant for all packets within the same flow. This ensures consistency in packet transmission and increases predictability within the network.

The difference between the finish time F(p) of packet p and the finish time F(p−1) of the previous packet at the first node is the same at all subsequent nodes. This means that packet transmission remains very consistent and predictable.

When the difference between the finish time F(p) of packet p at the first node and the finish time F(p−1) of the previous packet is the same at all subsequent nodes, the relationship in Equation 4 holds at all nodes.

$$F ( p ) = F ( p - 1 ) + {L}^{′} ( p ) / r \qquad [ Equation 4 ]$$

In Equation 4, the entire time is partitioned into intervals such as (0, F(1)], (F(2)−L′(2)/r, F(2)], and so on. Therefore, if arbitrary time t belongs to (F(p)−L′(p)/r, F(p)], it does not belong to any other interval. To determine the service rate of a given flow at arbitrary time t, the interval (F(p)−L′(p)/r, F(p)] to which arbitrary time t belongs is checked, i.e., verifying that F(p)−L′(p)/r<t≤F(p). Then, the value r from the metadata of packet p is read and used to estimate the service rate of the flow at time t.

In conclusion, to estimate a service rate of a flow, the metadata must include the values of F(p), L′(p), and r.

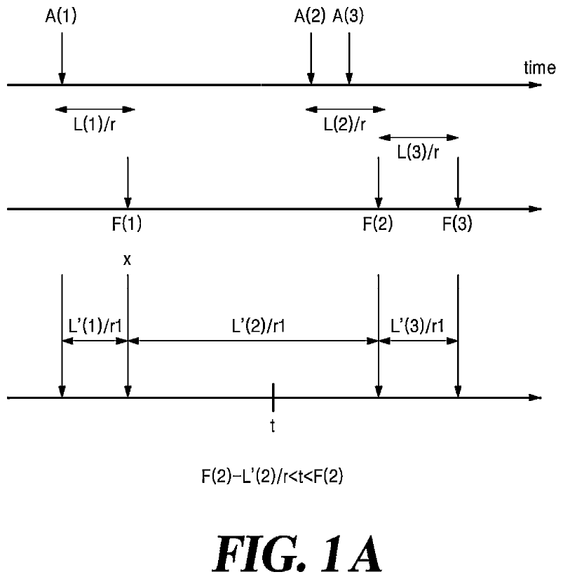

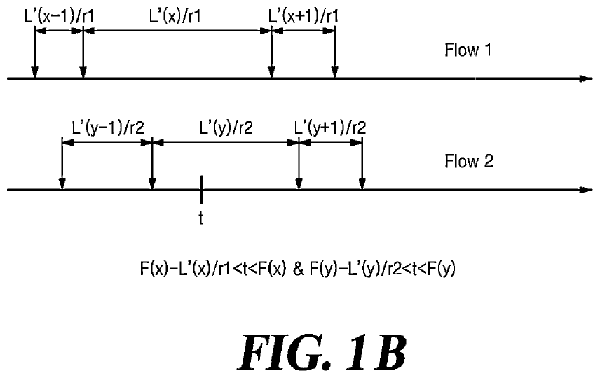

A method for identifying an interval which arbitrary time t falls within will be described with reference to FIGS. 1A and 1B.

FIGS. 1A and 1B show the relationships between A(p) and F(p), and L(p) and L′(p).

A total time is partitioned into intervals of L′(p)/r. Therefore, arbitrary time t falls within one (F(p)−L′(p)/r, F(p)].

In FIG. 1A, arbitrary time t falls within a time interval ((F(2)−L′(2)/r, F(2)]) partitioned by one flow.

In FIG. 1B, arbitrary time t falls within time intervals (F(x)−L′(x)/r, F(x)] and ((F(y)−L′(y)/r, F(y)] respectively partitioned by the two flows.

As in FIG. 1A, when there is only one flow, a method for tracking a finish time of a packet at each node and transmitting the packet to the next node using metadata may seem somewhat complicated. This is because when there is only one flow, there is little need to manage or predict inter-packet delay.

As in FIG. 1B, when there are two or more flows, the method for tracking a finish time of a packet at each node and transmitting the packet to the next node using metadata may be a powerful estimation method.

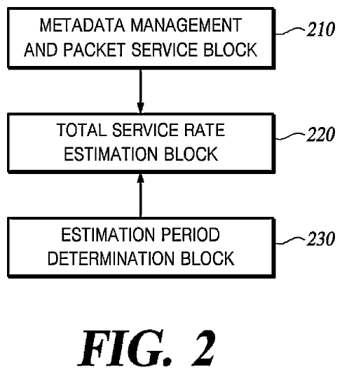

Referring to FIGS. 2 to 5, a method for estimating a total link service rate using packet metadata according to an embodiment of the present disclosure will be described.

FIG. 2 is a block diagram of an apparatus for estimating a total link service rate using packet metadata according to an embodiment of the present disclosure.

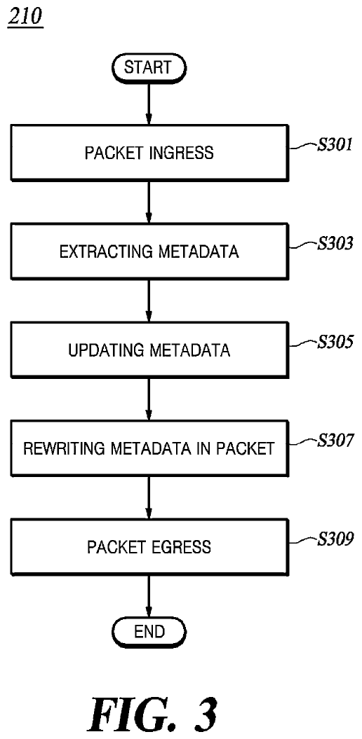

FIG. 3 is a flowchart illustrating the operation of a metadata management and packet service blocks according to an embodiment of the present disclosure.

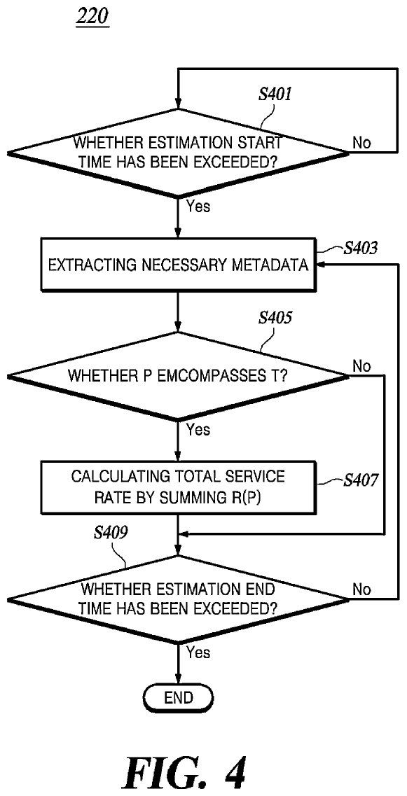

FIG. 4 is a flowchart illustrating the operation of a total link service rate estimation block according to an embodiment of the present disclosure.

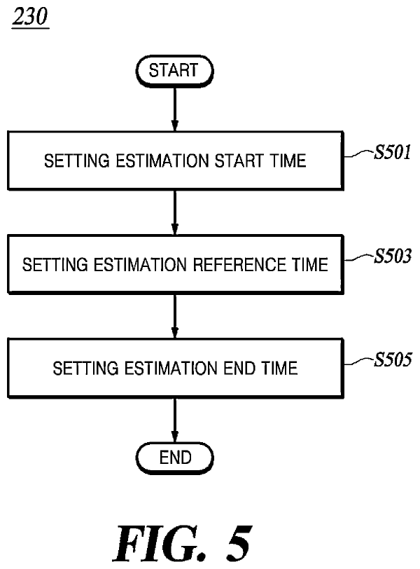

FIG. 5 is a flowchart illustrating the operation of an estimation period determination block according to an embodiment of the present disclosure.

Referring to FIG. 2, an apparatus for estimating a total link service rate using packet metadata according to an embodiment of the present disclosure includes a metadata management and packet service block 210, a total service rate estimation block 220, and an estimation period determination block 230. The metadata management and packet service block 210, the total service rate estimation block 220, and the estimation period determination block 230 operate in parallel to efficiently process and analyze data.

Referring to FIG. 3, the metadata management and packet service block 210 performs a packet ingress (S301). Then, the metadata management and packet service block 210 undergoes subsequent processing.

The metadata management and packet service block 210 extracts metadata from the packet header (S303). The metadata includes Fₕ₋₁(p), L′(p), r(p), and so on.

The metadata management and packet service block 210 updates the extracted metadata to match information required by the current node (S305). The updated metadata includes Fₕ(p), L′(p), r(p), and so on.

The metadata management and packet service block 210 rewrites the updated metadata back into the packet header (S307). The rewritten metadata includes Fₕ(p), L′(p), r(p), and so on.

The metadata management and packet service block 210 performs a packet egress with the updated metadata to the next node through the network (S309).

Meanwhile, referring to FIG. 4, the total service rate estimation block 220 determines whether the estimation start time has been exceeded in operation S401.

If the estimation start time has been exceeded, the total service rate estimation block 220 extracts necessary metadata in operation S403. The extracted metadata refers to the metadata updated in operation S305 and includes Fₕ(p), L′(p), r(p), and so on.

The total service rate estimation block 220 determines whether packet p, which satisfies the following Equation 5, encompasses time t (S405). Once time t is determined, a time interval that encompasses time t is determined, and packet p belonging to the determined time interval is identified.

If packet p encompasses time t, the total service rate estimation block 220 extracts r(p) from the metadata of packet p satisfying the following Equation 5 and calculates a total service rate by summing r(p) (S407). Here, r(p) represents the service rate of the flow to which packet p belongs. After calculating the total service rate, the total service rate estimation block 220 proceeds to operation S409.

On the other hand, if packet p does not encompass time t, the total service rate estimation block 220 proceeds to operation S409.

The total service rate estimation block 220 determines whether the estimation end time has been exceeded (S409).

If the estimation end time has not been exceeded, the total service rate estimation block 220 proceeds to operation S403.

On the other hand, if the estimation end time has been exceeded, the total service rate estimation block 220 terminates the operation.

Meanwhile, referring to FIG. 5, the estimation period determination block 230 sets an estimation start time (t−Ts) (S501). In other words, the estimation period determination block 230 sets a starting point of estimation in order to determine an estimation period. Ts is determined using Equation 6, which will be described later.

The estimation period determination block 230 sets an estimation reference time (t) (S503). That is, the estimation period determination block 230 sets a reference time to be used during the estimation. The estimation reference time (t) is used in operation S405.

The estimation period determination block 230 sets an estimation end time (t+Te) (S505). That is, the estimation period determination block 230 sets a time at which the estimation is to be completed.

Te is determined using Equation 7, which will be described later.

Hereinafter, a method for estimating a total service rate and determining estimation start and end times will be described.

A total service rate of flows sharing a specific link at a specific point in time may be estimated in a similar manner. However, in this case, it is assumed that which flow a specific packet p belongs to is unknown. For example, let's estimate a total service rate TR when two flows coexist, as shown in FIG. 1B.

Hereinafter, an apparatus for estimating a total link service rate using packet metadata will be referred to as a “total link service rate estimating apparatus.”

First, the total link service rate estimating apparatus determines the estimation reference time t and compares the packet's finish time F(p) and F(p)−L′(p)/r(p) with the estimation reference time t, as shown in Equation 5. Here, r(p) represents a service rate of a flow to which p belongs. The sum of the extracted r(p) values from packets p that satisfy Equation (5) becomes TR. By doing so, an embodiment of the present disclosure may verify the service rate of a specific flow or link, and based on this, achieve network optimization.

$$f ( p ) - \frac{{L}^{′} ( p )}{r} < t \leq F ( p ) \qquad [ Equation 5 ]$$

Let's define that packet p satisfying Equation 5 “encompasses” the estimation reference time t. This embodiment of the present disclosure is based on the fact that there is only one packet having a finish time that encompasses an estimation reference time. To make this estimation, metadata values F(p), L′(p), and r(p) are required.

The estimation start time refers to a time when a search begins for packets p that encompass the estimation reference time t, while the estimation end time refers to a time when a search for these encompassing packets p ends.

The estimation reference time is set to be a time sufficiently later than the estimation start time.

For example, if the estimation start time is t*, the estimation reference time t is determined as (t*+Ts). Packet inspection begins at the estimation start time. By doing so, it is possible to inspect and extract all packets that encompass the estimation reference time. That is, any arbitrary packet p satisfying Aₕ(p)<t* follows Fₕ(p)<t*+Ts=t, and therefore, packet p does not satisfy Equation 5. This may be proven as follows.

Let's define DF as the upper bound of the sum of the delay factors dₕ(p) from 0 to h−1 for arbitrary packet p and h. That is, Σₖ₌₀^{h-1}dₖ(p)≤DF is satisfied.

In this case, Fₕ(p)≤F₀(p)+DF is satisfied.

In [C-SCORE], F₀(p)=Ba(p)/r(p)+A₀(a) is satisfied by Lemma 2. Here, a is defined as an activation packet of an active period to which p belongs. Ba(p) is the sum of packet lengths of packets from a to p. Packet a precedes packet p or packets a and p are the same packet (a≤p).

Therefore, Fₕ(p)≤Ba(p)/r(p)+A₀(a)+DF≤Ba(p)/r(p)+A₀(p)+DF≤K Ba(p)/r(p)+Aₕ(p)+DF. Thus, if arbitrary packet p satisfies Aₕ(p)≤t*, Fₕ(p)≤t*+Ba(p)/r(p)+DF is satisfied. Therefore, as Equation 6 is set as below, it can be proven that packets arriving before the estimation start time t* do not satisfy Equation 5.

$$Ts = {max}_{p} [ \frac{Ba ( p )}{r ( p )} ] + DF \qquad [ Equation 6 ]$$

Here, a maximum value of Ba(p) is B(p), which is a maximum burst size of a flow to which packet p belongs.

Meanwhile, the estimation end time for packet inspection is determined to be sufficiently later than the estimation reference time.

For example, the estimation end time is determined as (t+Te). Packets arriving after the estimation end time t+Te do not satisfy Equation 5. This is proven as follows.

In [C-SCORE], Cₕ(p)<Fₕ(p) is satisfied by Theorem 2. Here, Cₕ(p) refers to a point in time at which the service of packet p is completed at node h. Thus, Aₕ(p)<Cₕ(p)<Fₕ(p) is satisfied. If p* represents a packet arriving at node h at time (t+Te), Aₕ(p*)<Fₕ(p*) is satisfied. Therefore, t+Te=Aₕ(p*)<Fₕ(p*) is satisfied, and if Te is set as shown in Equation 7 below, the Fₕ(p) values of all packets arriving afterward, including p*, are greater than t+L′(p)/r(p). Such packets do not satisfy Equation 5.

$$Te = {max}_{p} [ \frac{{L}^{′} ( p )}{r ( p )} ] \qquad [ Equation 7 ]$$

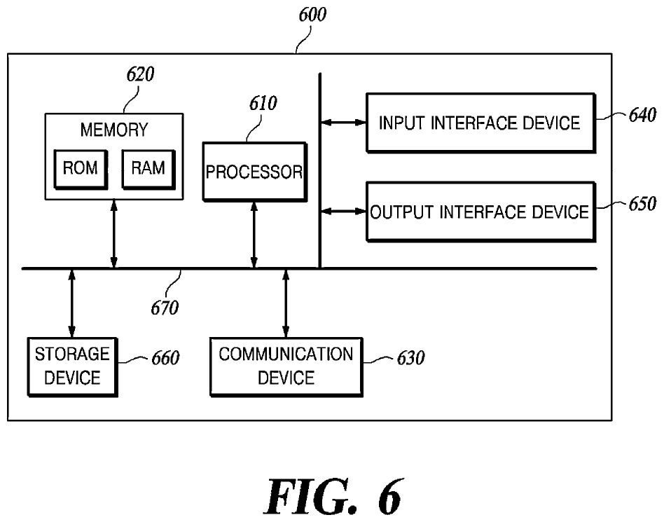

FIG. 6 is another block diagram of an apparatus for estimating a total link service rate using packet metadata according to an embodiment of the present disclosure.

Referring to FIG. 6, a communication node 600, which is a total link service rate estimating apparatus, may include at least one processor 610, a memory 620, and a communication device 630 connected to a network for communication. In addition, the communication node 600 may further include an input interface device 640, an output interface device 650, and a storage device 660. Each of the components included in the communication node 600 may be connected through a bus 670 to communicate with each other.

However, each of the components included in the communication node 600 may be connected through individual interfaces or individual buses centered around the processor 610, instead of the shared bus 270. For example, the processor 610 may be connected to at least one of the memory 620, the communication device 630, the input interface device 640, the output interface device 650, and the storage device 660 through a dedicated interface.

The processor 610 may execute a program command stored in at least one of the memory 620 and the storage device 660. The processor 610 may refer to a central processing unit (CPU), a graphics processing unit (GPU), or a dedicated processor on which methods according to embodiments of the present disclosure are performed. Each of the memory 620 and the storage device 660 may be composed of at least one of a volatile storage media and a non-volatile storage media. For example, the memory 620 may be composed of at least one of a read-only memory (ROM) and a random access memory (RAM).

The processor 610 extracts a packet satisfying a predetermined condition from each flow by executing a command, extracts a link service rate from metadata of the extracted packet, and estimates a total link service rate based on the extracted link service rate. The packet satisfying the predetermined condition is determined based on an estimation reference time and finish times of consecutive packets. The finish times indicate the ideal transmission finish times of the packets.

The processor 610 partitions a total time of each flow into a plurality of time intervals corresponding to the consecutive packets based on the finish times of the consecutive packets, and determines packets satisfying the predetermined condition based on the time interval to which the estimation reference time belongs among the plurality of time intervals.

When the estimation reference time is greater than a finish time of a previous packet and the estimation reference time is less than or equal to a finish time of the current packet, the processor 610 extracts the current packet as a packet satisfying the predetermined condition.

The processor 610 estimates a total link service rate by summing link service rates. The packet is extracted as one packet per flow.

Here, the predetermined condition satisfies Equation 5.

In this case, t represents the estimation reference time, F(p) represents the finish time of the current packet p, L′(p) represents a difference between the finish times of consecutive packets, and r represents a service rate of a flow to which packet p belongs.

The finish time is determined by Equation 4.

In Equation 4, F(p) represents the finish time of the current packet p, F(p−1) represents the finish time of the previous packet p−1, L′(p) represents the difference in finish times between consecutive packets, and r represents a service rate of a flow to which packet p belongs.

The above estimation reference time is determined to be between the estimation start time and the estimation end time.

When the estimation start time is t′, the estimation reference time is determined as t′+Ts, and the Ts is determined by Equation 6.

In Equation 6, a maximum value of Ba(p) represents a maximum burst size of a flow to which the extracted packet p belongs, r(p) represents the service rate of the flow to which the extracted packet p belongs, and DF represents a delay factor.

If the estimation start time is t′, the estimation end time is determined as t′+Ts+Te. In this case, Te is determined by Equation 7.

In Equation 7, L′(p) represents a difference between finish times of consecutive packets, and r(p) represents a service rate of a flow to which the extracted packet p belongs.

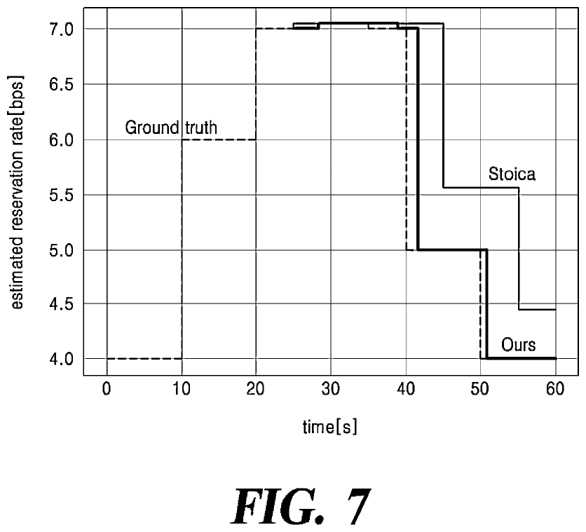

FIG. 7 is a graph showing an estimation result according to an embodiment of the present disclosure and a result of comparison with Stoica.

The dotted line represents the ground truth, the bold line indicates a total link service rate estimation result according to an embodiment of the present disclosure, and the solid line represents a total link service rate estimation result from Stoica.

Through the graph of FIG. 7, it can be observed that the total link service rate estimation results according to an embodiment of the present disclosure are closer to the ground truth.

The components described in the example embodiments may be implemented by hardware components including, for example, at least one digital signal processor (DSP), a processor, a controller, an application-specific integrated circuit (ASIC), a programmable logic element, such as an FPGA, other electronic devices, or combinations thereof. At least some of the functions or the processes described in the example embodiments may be implemented by software, and the software may be recorded on a recording medium. The components, the functions, and the processes described in the example embodiments may be implemented by a combination of hardware and software.

The method according to example embodiments may be embodied as a program that is executable by a computer, and may be implemented as various recording media such as a magnetic storage medium, an optical reading medium, and a digital storage medium.

Various techniques described herein may be implemented as digital electronic circuitry, or as computer hardware, firmware, software, or combinations thereof. The techniques may be implemented as a computer program product, i.e., a computer program tangibly embodied in an information carrier, e.g., in a machine-readable storage device (for example, a computer-readable medium) or in a propagated signal for processing by, or to control an operation of a data processing apparatus, e.g., a programmable processor, a computer, or multiple computers. A computer program(s) may be written in any form of a programming language, including compiled or interpreted languages and may be deployed in any form including a stand-alone program or a module, a component, a subroutine, or other units suitable for use in a computing environment. A computer program may be deployed to be executed on one computer or on multiple computers at one site or distributed across multiple sites and interconnected by a communication network.

Processors suitable for execution of a computer program include, by way of example, both general and special purpose microprocessors, and any one or more processors of any kind of digital computer. Generally, a processor will receive instructions and data from a read-only memory or a random access memory or both. Elements of a computer may include at least one processor to execute instructions and one or more memory devices to store instructions and data. Generally, a computer will also include or be coupled to receive data from, transfer data to, or perform both on one or more mass storage devices to store data, e.g., magnetic, magneto-optical disks, or optical disks. Examples of information carriers suitable for embodying computer program instructions and data include semiconductor memory devices, for example, magnetic media such as a hard disk, a floppy disk, and a magnetic tape, optical media such as a compact disk read only memory (CD-ROM), a digital video disk (DVD), etc. and magneto-optical media such as a floptical disk, and a read only memory (ROM), a random access memory (RAM), a flash memory, an erasable programmable ROM (EPROM), and an electrically erasable programmable ROM (EEPROM) and any other known computer readable medium. A processor and a memory may be supplemented by, or integrated into, a special purpose logic circuit.

The processor may run an operating system (OS) and one or more software applications that run on the OS. The processor device also may access, store, manipulate, process, and create data in response to execution of the software. For purpose of simplicity, the description of a processor device is used as singular; however, one skilled in the art will be appreciated that a processor device may include multiple processing elements and/or multiple types of processing elements. For example, a processor device may include multiple processors or a processor and a controller. In addition, different processing configurations are possible, such as parallel processors.

Also, non-transitory computer-readable media may be any available media that may be accessed by a computer, and may include both computer storage media and transmission media.

The present specification includes details of a number of specific implements, but it should be understood that the details do not limit any invention or what is claimable in the specification but rather describe features of the specific example embodiment. Features described in the specification in the context of individual example embodiments may be implemented as a combination in a single example embodiment. In contrast, various features described in the specification in the context of a single example embodiment may be implemented in multiple example embodiments individually or in an appropriate sub-combination. Furthermore, the features may operate in a specific combination and may be initially described as claimed in the combination, but one or more features may be excluded from the claimed combination in some cases, and the claimed combination may be changed into a sub-combination or a modification of a sub-combination.

Similarly, even though operations are described in a specific order on the drawings, it should not be understood as the operations needing to be performed in the specific order or in sequence to obtain desired results or as all the operations needing to be performed. In a specific case, multitasking and parallel processing may be advantageous. In addition, it should not be understood as requiring a separation of various apparatus components in the above described example embodiments in all example embodiments, and it should be understood that the above-described program components and apparatuses may be incorporated into a single software product or may be packaged in multiple software products.

It should be understood that the example embodiments disclosed herein are merely illustrative and are not intended to limit the scope of the invention. It will be apparent to one of ordinary skill in the art that various modifications of the example embodiments may be made without departing from the spirit and scope of the claims and their equivalents.

Accordingly, one of ordinary skill would understand that the scope of the claimed invention is not to be limited by the above explicitly described embodiments but by the claims and equivalents thereof.

What is claimed is:

1. A method for estimating a total link service rate using packet metadata, the method comprising:
extracting a packet satisfying a predetermined condition from each flow;
extracting a link service rate from metadata of the extracted packet; and
estimating a total link service rate based on the extracted link service rate,
wherein the packet satisfying the predetermined condition is determined based on an estimation reference time and finish times of consecutive packets, and
wherein the finish times indicates ideal transmission finish times of the packets.

2. The method of claim 1, wherein the extracting of a packet satisfying the predetermined condition comprises:
partitioning a total time of each flow into a plurality of time intervals respectively corresponding to the consecutive packets, based on the finish times of the consecutive packets; and
determining the packet satisfying the predetermined condition based on a time interval to which the estimation reference time belongs among the plurality of time intervals.

3. The method of claim 1, wherein the extracting of a packet satisfying the predetermined condition comprises extracting a current packet as a packet satisfying the predetermined condition when the estimation reference time is greater than a finish time of a previous packet and the estimation reference time is less than or equal to a finish time of the current packet.

4. The method of claim 1, wherein the estimating of a total link service rate comprises estimating a total link service rate by summing link service rates.

5. The method of claim 1, wherein the packet is extracted as one packet per flow.

6. The method of claim 1, wherein the predetermined condition satisfies Equation as follows:
$$f ( p ) - \frac{{L}^{′} ( p )}{r} < t \leq F ( p ) , \qquad [ Equation ]$$
where t represents the estimation reference time, F(p) represents the finish time of the current packet p, L′(p)/r represents a difference between the finish times of the consecutive packets, and r represents a service rate of a flow to which packet p belongs.

7. The method of claim 6, wherein the finish times are determined by Equation as follows:
$$F ( p ) = F ( p - 1 ) + {L}^{′} ( p ) / r , \qquad [ Equation ]$$
where F(p) represents the finish time of the current packet p, F(p−1) represents a finish time in previous packet p−1, L′(p)/r represents a difference between the finish times of the consecutive packets, and r represents a service rate of a flow to which packet p belongs.

8. The method of claim 1, wherein the estimation reference time is determined to be between the estimation start time and the estimation end time.

9. The method of claim 8,
wherein the estimation reference time is determined as t′+Ts when the estimation start time is t when the estimation start time is t′, and
wherein Ts is determined by Equation as follows:
$$Ts = {max}_{p} \{ Ba ( p ) / r ( p ) \} + DF , \qquad [ Equation ]$$
where a maximum value of Ba(p) represents a maximum burst size of a flow to which the extracted packet p belongs, r(p) represents a service rate of the flow belonging to the extracted packet p, and DF represents a delay factor.

10. The method of claim 9,
wherein the estimation end time is determined as t′+Ts+Te when the estimation start time is t′, and
wherein Te is determined by Equation as follows:
$$Te = {max}_{p} \{ \frac{{L}^{′} ( p )}{r ( p )} \} , \qquad [ Equation ]$$
where L′(p)/r(p) represents a difference between the finish times of the consecutive packets, and r(p) represents a service rate of a flow to which the extracted packet p belongs.

11. An apparatus for estimating a total link service rate using packet metadata, the apparatus comprising:
a memory having a command stored therein; and
a processor configured to extract a packet satisfying a predetermined condition from each flow by executing the command, extract a link service rate from metadata of the extracted packet, and estimate a total link service rate based on the extracted link service rate,
wherein the packet satisfying the predetermined condition is determined based on an estimation reference time and finish times of consecutive packets, and
wherein the finish times indicate ideal transmission finish times of the packets.

12. The apparatus of claim 11, wherein the processor is further configured to partition a total time of each flow into a plurality of time intervals respectively corresponding to the consecutive packets, based on the finish times of the consecutive packets, and to determine the packet satisfying the predetermined condition based on a time interval to which the estimation reference time belongs among the plurality of time intervals.

13. The apparatus of claim 11, wherein the processor is further configured to extract a current packet as a packet satisfying the predetermined condition when the estimation reference time is greater than a finish time of a previous packet and the estimation reference time is less than or equal to a finish time of the current packet.

14. The apparatus of claim 11, wherein the processor is further configured to estimate a total link service rate by summing link service rates.

15. The apparatus of claim 11, wherein the packet is extracted as one packet per flow.

16. The apparatus of claim 11, wherein the predetermined condition satisfies Equation as follows:
$$f ( p ) - \frac{{L}^{′} ( p )}{r} < t \leq F ( p ) , \qquad [ Equation ]$$
Where t represents the estimation reference time, F(p) represents the finish time of the current packet p, L′(p)/r represents a difference between the finish times of the consecutive packets, and r represents a service rate of a flow to which packet p belongs.

17. The apparatus of claim 16, wherein the finish times are determined by Equation as follows:
$$F ( p ) = F ( p - 1 ) + {L}^{′} ( p ) / r , \qquad [ Equation ]$$
where F(p) represents the finish time of the current packet p, F(p−1) represents a finish time in previous packet p−1, L′(p)/r represents a difference between the finish times of the consecutive packets, and r represents a service rate of a flow to which packet p belongs.

18. The apparatus of claim 11, wherein the estimation reference time is determined to be between the estimation start time and the estimation end time.

19. The apparatus of claim 18,
wherein the estimation reference time is determined as t′+Ts when the estimation start time is t when the estimation start time is t′, and
wherein Ts is determined by Equation as follows:
$$Ts = {max}_{p} \{ Ba ( p ) / r ( p ) \} + DF , \qquad [ Equation ]$$
where a maximum value of Ba(p) represents a maximum burst size of a flow to which the extracted packet p belongs, r(p) represents a service rate of the flow belonging to the extracted packet p, and DF represents a delay factor.

20. The apparatus of claim 19,
wherein the estimation end time is determined as t′+Ts+Te when the estimation start time is t′, and
wherein Te is determined by Equation as follows:
$$Te = {max}_{p} \{ \frac{{L}^{′} ( p )}{r ( p )} \} , \qquad [ Equation ]$$
where L′(p)/r(p) represents a difference between the finish times of the consecutive packets, and r(p) represents a service rate of a flow to which the extracted packet p belongs.
